(19) United States
(12) Patent Application Publication
(10) Pub. No.: US 2024/0351818 A1
(43) Pub. Date: Oct. 24, 2024

(54) ARTICULATING PAPER DISPENSER AND RELATED METHODS OF USE AND INSTALLATION

(71) Applicant: 1360625 B.C. LTD., Vernon (CA)

(72) Inventor: Anthony Berdan, Vernon (CA)

(21) Appl. No.: 18/639,774

(22) Filed: Apr. 18, 2024

Related U.S. Application Data
(60) Provisional application No. 63/497,166, filed on Apr. 19, 2023.

(51) Int. Cl. B65H 35/00; A61C 19/05

(52) U.S. Cl. CPC B65H 35/002; A61C 19/05; B65H 35/008; B65H 2301/51532; B65H 2301/5154

(57) ABSTRACT

An articulating paper dispenser comprising: an articulating-paper-roll retainer with a housing that defines an articulating-roll-receiving interior and a paper outlet; a blade arm extended from the housing and defining a finger-receiving pincer zone between the housing and the blade arm, the blade arm mounting a paper-cutting blade that is oriented to cut articulating paper that extends, in use, across a mouth gap that opens into the finger-receiving pincer zone and is defined between the paper outlet and the paper-cutting blade.

### TECHNICAL FIELD

This disclosure relates generally to medical equipment and in particular to a method and apparatus for dispensing articulating paper.

### BACKGROUND

The following paragraphs are not an admission that anything discussed in them is prior art or part of the knowledge of persons skilled in the art.

In dentistry, it is commonly necessary to check the connection between bite surface of top and bottom teeth, referred to as the occlusion. One common way of doing this is to provide a strip of paper having a die or ink on both sides between the patient's teeth on which the patent can then bite to indicate high spots between the teeth. Articulating paper is typically provided in roll form, within a cartridge. One difficulty with current bite registration paper cartridges and rolls is that there is no way to dispense the articulating paper without contaminating the surfaces of the dentist's hands, requiring re-gloving or additional steps. Moreover, a dentist or other professional may at the same time have other equipment in their hands. As such, it may be difficult to cut or otherwise prepare an appropriately sized strip when desired in a time and cost-effective manner.

### SUMMARY

An articulating paper dispenser comprising: an articulating-paper-roll retainer with a housing that defines an articulating-roll-receiving interior and a paper outlet; a blade arm extended from the housing and defining a finger-receiving pincer zone between the housing and the blade arm, the blade arm mounting a paper-cutting blade that is oriented to cut articulating paper that extends, in use, across a mouth gap that opens into the finger-receiving pincer zone and is defined between the paper outlet and the paper-cutting blade.

A method is disclosed, comprising gripping a strip of articulating paper, which is fed from a roll through a paper channel and outlet defined in an articulating-paper-roll retainer, and severing a length of the articulating paper by contacting the paper at an intermediate location with a blade arm extended from the retainer, in which the blade arm and retainer define a finger-receiving pincer zone to permit the user to grip the strip below the retainer without touching the retainer or blade arm.

According to a first embodiment, there is disclosed an apparatus for dispensing a length of bite registration tape comprising a body having a receiving passage sized to correspond to a cartridge of bite registration tape, an arm extending around a gap from the body to a distal end and a cutting blade at the distal end of the arm.

According to a further embodiment, there is disclosed a method of dispensing a portion of bite registration tape comprising locating a bite registration cartridge within a passage of a body, gripping an end of the bite registration paper within a gap defined between the body and an arm extending away therefrom, and pulling the bite registration paper across a cutting surface in a distal end of the arm to cut the bite registration paper.

Other aspects and features of the present disclosure will become apparent to those ordinarily skilled in the art upon review of the following description of specific embodiments in conjunction with the accompanying figures.

In various embodiments, there may be included any one or more of the following features: The blade arm depends below a base of the housing. The blade arm comprises a branch base part and a stem part; the stem part mounts the paper-cutting blade; and the branch base part depends from at or near a rear end of the housing. The stem part extends parallel with an underside of the base of the housing to define the finger-receiving pincer zone. A lateral terminal tip of the stem part mounts the paper-cutting blade. A pressure adjuster part structured to apply adjustable friction pressure to articulating paper that is mounted, in use, within the articulating-paper-roll retainer. The pressure adjuster part comprises a threaded knob. The pressure adjuster part comprises, or is structured to engage, the articulating paper or a cantilever part that is, at least in use, within the articulating-roll-receiving interior and is oriented to swing radially inward with advancement of the pressure adjuster part, to selectively reduce an articulating-paper-thickness gap defined between an articulating-paper ramp and the cantilever part. The cantilever part is mounted to depend from an inner surface of the housing in the articulating-roll-receiving interior. The cantilever part and the articulating-paper ramp are located at or near a front end of the articulating-roll-receiving interior. The pressure adjuster part is structured to engage a cantilever part of an articulating-paper roll cartridge mounted, in use, within the articulating-roll-receiving interior. The articulating-paper-roll retainer is structured to receive, in use, an articulating-paper-roll cartridge. The housing has a peripheral encircling wall that is split at a front part to define the paper outlet, with the peripheral encircling wall defining a paper roll mounting axis. The housing defines opposed sides, which are bounded by the peripheral encircling wall, and one or more of which are open. An open side of the opposed sides is defined by a paper-roll insertion door. The other of the opposed sides is defined by a cover wall. Wall-mounting fastener holes in a rear wall facing part of the articulating paper dispenser. A method comprising mounting an articulating paper roll within the articulating-roll-receiving interior of the articulating paper dispenser.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a perspective view of an articulating paper dispenser with a paper-cutting blade and a housing for an articulating-paper-roll.

FIG. 2 is a first side elevation view of the articulating paper dispenser of FIG. 1.

FIG. 3 is a second side elevation view of the articulating paper dispenser of FIG. 1.

FIG. 4 is an exploded view of the articulating paper dispenser of FIG. 1, with a threaded pressure adjusting knob illustrated.

FIG. 5 is an exploded view of the articulating paper dispenser of FIG. 1, illustrating the articulating paper dispenser mounted to a wall.

FIG. 6 is a cross-section view of the articulating paper dispenser of FIG. 1.

FIG. 7 is a rear end view of the articulating paper dispenser of FIG. 1.

FIG. 8 is a front-end view of the articulating paper dispenser of FIG. 1.

FIG. 9 is a bottom plan view of the articulating paper dispenser of FIG. 1.

FIG. 10 is a top plan view of the articulating paper dispenser of FIG. 1.

FIG. 11 is a perspective view of another embodiment of an articulating paper dispenser with an articulating-paper-roll retainer and mounting an articulating-paper-roll cartridge.

FIG. 12 is a perspective view of the articulating paper dispenser of FIG. 11, with the articulating-paper-roll cartridge removed from the articulating-paper-roll retainer.

FIG. 13 is a side elevation view of the articulating paper dispenser of FIG. 11, with the articulating paper dispenser mounted to a wall, and the wall shown in section.

### DETAILED DESCRIPTION

Immaterial modifications may be made to the embodiments described here without departing from what is covered by the claims.

The field of dentistry encompasses a multifaceted field dedicated to the diagnosis, prevention, and treatment of oral diseases and conditions. It involves an array of specialized procedures ranging from routine dental cleanings and cavity fillings to complex surgical interventions such as dental implants and orthodontic treatments. Dentists and related dentistry professionals play an important role in promoting overall health by addressing oral health issues that can impact systemic well-being, including cardiovascular disease and diabetes. Practices in the field of dentistry collaborate with various medical specialties to provide comprehensive care tailored to individual patient needs, and emphasizes the importance of oral hygiene practices and regular dental check-ups for maintaining optimal oral health.

An occlusion in dentistry terms refers to the alignment and contact between the teeth of the upper and lower jaws when they come into contact during biting or chewing. Achieving proper occlusion is important for optimal dental function, stability, and overall oral health. The study of occlusion involves assessing factors such as the arrangement of teeth, jaw relationship, and muscle function to identify any irregularities or malocclusions that may affect a patient's bite. A malocclusion may lead to issues such as bruxism (teeth grinding), temporomandibular joint (TMJ) disorders, and uneven wear of the teeth. Dentists may employ various diagnostic tools, including articulating paper and digital occlusal analysis systems, to evaluate occlusal contacts and make necessary adjustments through treatments such as orthodontics, dental restorations, or occlusal splints.

Articulating paper is a diagnostic tool used in dentistry to assess occlusal contacts and adjust dental restorations for proper bite alignment. Articulating paper comprises a thin, coated paper or film with a color transfer agent. In use the paper is placed between the upper and lower teeth during occlusal adjustments. When the patient bites down, the paper leaves marks on the contacting surfaces, indicating areas of high pressure or premature contact. A dentist may analyze these marks to identify occlusal discrepancies, such as interference points or uneven distributions of force, which can lead to discomfort or dysfunction. The dentist may use the information provided by articulating paper to selectively adjust the restoration or make occlusal adjustments to achieve harmonious occlusion, promoting optimal dental function and stability.

Articulating paper is provided to dentistry professionals in the form of individual rolls or single-roll cartridges. Individual rolls are commonly available, providing convenient access to a single roll of articulating paper. These rolls come in various widths to accommodate diverse clinical applications. Additionally, articulating paper is also marketed in roll-containing cartridges. Cartridges ensure efficient usage and reduce wastage by providing a controlled dispensing mechanism, enhancing precision and minimizing contamination risks during application. Overall, the availability of articulating paper in both individual rolls and roll-containing cartridges enables dental professionals to select the most suitable format based on their workflow preferences and clinical requirements.

Hygiene practices in dental surgery encompass a range of protocols aimed at preventing the transmission of infectious agents and maintaining a sterile environment. The oral cavity harbors a diverse microbial population, as well as entry points to the bloodstream, making stringent hygiene protocols imperative to reduce the risk of cross-contamination and patient infection. To address these potential risks, dental practices adhere to strict infection control guidelines established by organizations such as the Centers for Disease Control and Prevention (CDC) and the World Health Organization (WHO). Implementing standard precautions, which involve practicing hand hygiene, wearing personal protective equipment (PPE) like gloves, masks, and protective eyewear, and ensuring proper disinfection and sterilization of instruments and surfaces, is crucial for preventing or minimizing the transmission of infectious agents. Additionally, dental surgery practices often employ engineering controls such as high-volume evacuation systems and air filtration units to minimize the spread of aerosols generated during procedures. Regular monitoring and auditing of hygiene practices, along with ongoing staff education and training, are standard components of an effective infection control program in dental surgery.

In dental practice, glove hygiene is important due to its role in infection control and prevention. Dentists and dental assistants must adhere to protocols regarding glove usage to minimize the risk of cross-contamination between patients and to maintain a sterile environment. It is imperative for a professional not to touch any non-sterile surfaces or objects while wearing gloves, as this can compromise the integrity of the sterile gloves and potentially transfer pathogens. Re-gloving is a term used to describe a protocol where a dentistry professional removes and discards a pair of gloves, and dons a new, sterile pair of gloves, during a procedure. Any contact with contaminated surfaces necessitates re-gloving to prevent the transmission of infectious agents to patients. Re-gloving may also need to be done after completing specific tasks within a procedure to maintain aseptic conditions. Adherence to meticulous glove hygiene protocols is important for ensuring patient safety and preventing healthcare-associated infections in dental settings.

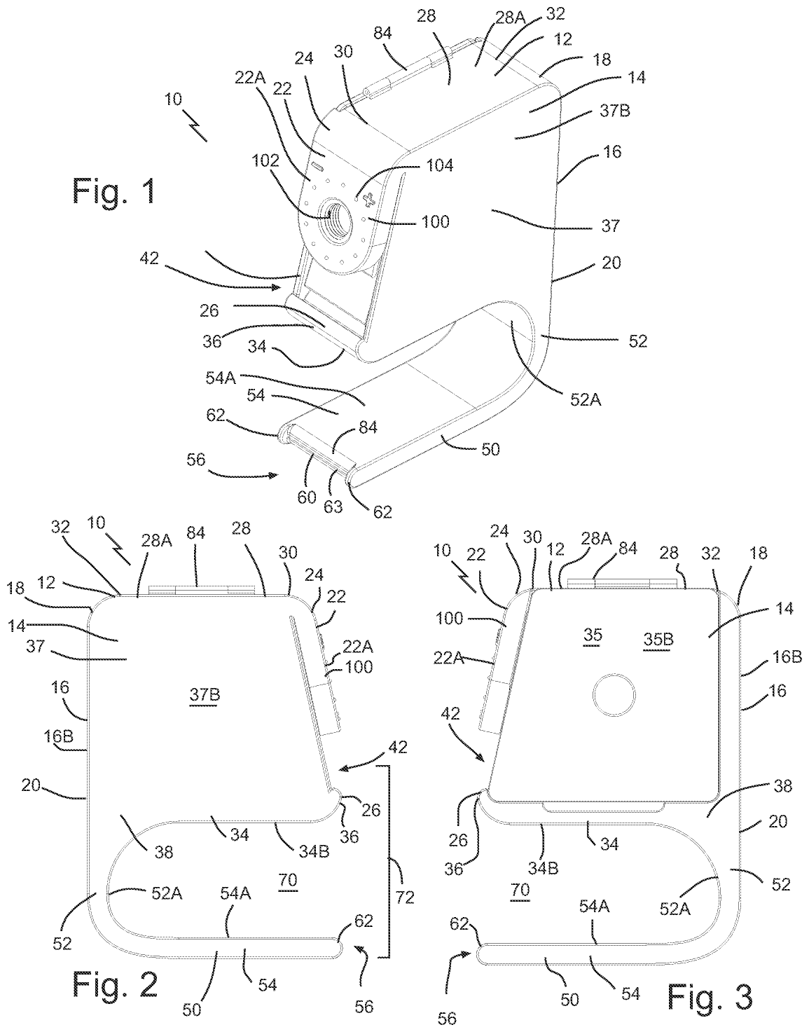

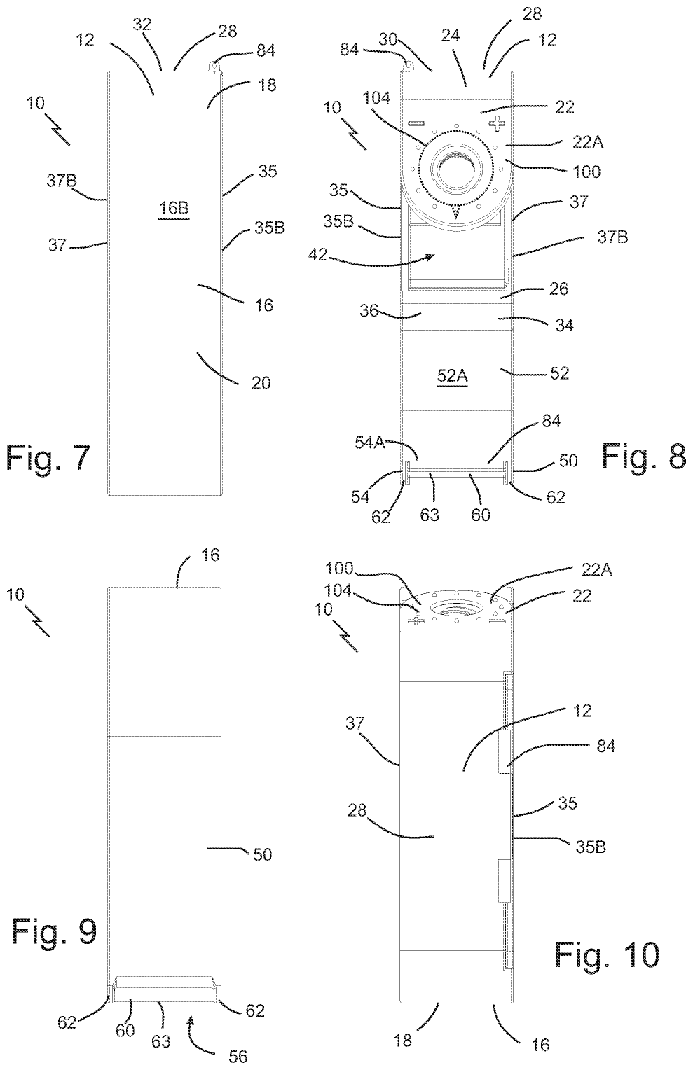

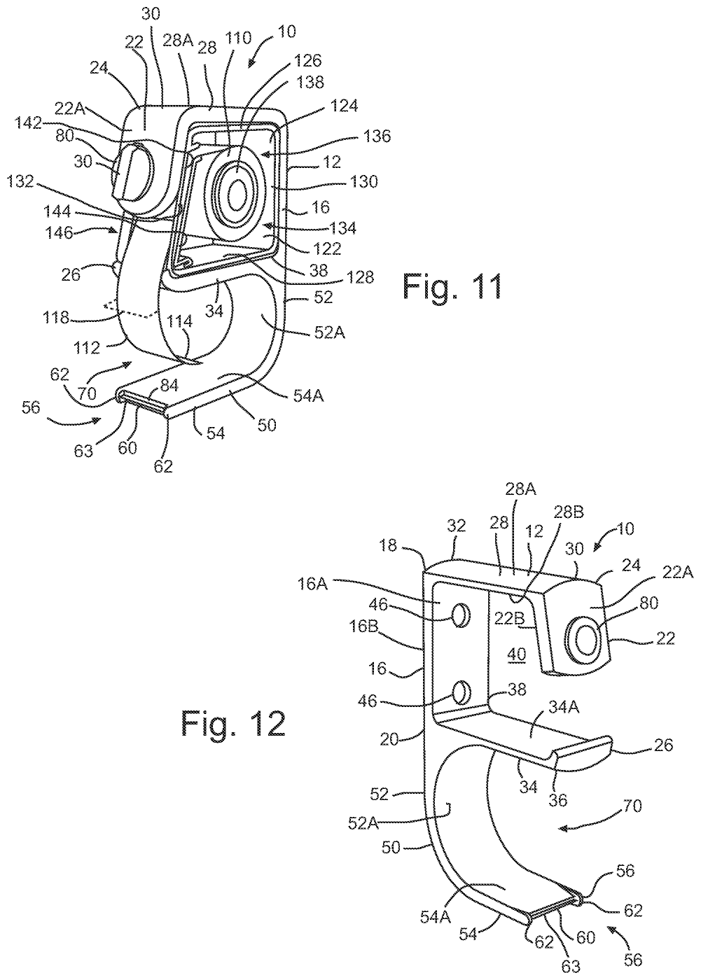

Referring to FIGS. 1-10, an articulating paper dispenser 10 is disclosed. the articulating paper dispenser 10 comprises an articulating-paper-roll retainer 12 and a blade arm 50. The articulating-paper-roll retainer 12 may form a housing 14 that defines an articulating-roll-receiving interior 40 and a paper outlet 42. The blade arm 50 may extended from the housing 25 and define a finger-receiving pincer zone 70 between the housing 14 and the blade arm 50. The blade arm 50 may mount a paper-cutting blade 60. The paper-cutting blade 60 may be oriented to cut an articulating paper strip 112. The articulating paper strip 112 may extend across a mouth gap 72 that may open into the finger-receiving pincer zone 70 and may be defined between the paper outlet 42 and the paper-cutting blade 60. In use, the dispenser 10 may be mounted to a wall 108 surface. A dentist or related professional may load the dispenser 10 by inserting either a paper roll 110 or cartridge 122 (FIG. 11), with a terminal end 114 of the roll 110 extended out of the paper outlet 42. In use, during surgery or other procedures, a dentist or related professional may pincer the terminal end 114, drawing a sufficient length of paper strip 112 out of the dispenser 10, and contacting the strip 112 against the blade 60 to cut the strip 112 from the roll 110. Thereafter, the dentist or related professional may use the cut paper strip 112 to measure occlusion of a patient's teeth.

Referring to FIGS. 1-10, the housing 14 may have a suitable structure. The housing 14 may comprise a peripheral encircling wall 15. The peripheral encircling wall 15 may be formed by a rear wall 16, a front wall 22, a top wall 28, and a base wall 34. The rear wall 16 may define an inner face 16A, an outer face 16B, a top edge 18 and a bottom edge 20. The outer face 16B of the rear wall 16 may define a wall-contacting face or surface. The top wall 28 may define an outer face 28A, and inner face 28B, a front edge 30 and a rear edge 32. The rear edge 32 of the top wall 28 may abut the top edge 18 of the rear wall 16. The front wall 22 may define an outer face 22A, an inner face 22B, a top edge 24 and a bottom edge 26. The top edge 24 of the front wall 22 may abut the front edge 30 of the top wall 28. The base wall 34 may define an inner face 34A, an outer face 34B, a front edge 36 and a rear edge 38. The front edge 36 of the base wall 34 may abut the bottom edge 26 of the front wall 22. The rear edge 38 of the base wall 34 may abut the bottom edge 20 of the rear wall 16.

Referring to FIGS. 1-10, the peripheral encircling wall 15 may have a suitable structure. The peripheral encircling wall 15 may be split at a front part, such as the front wall 22 to define the paper outlet 42. The peripheral encircling wall 15 may define a paper roll mounting axis 44, which also defines a paper roll rotation axis. Opposed sides of the housing 14 may be bounded by the peripheral encircling wall 15. Wall-mounting fastener bores 46 may be defined in the rear wall 16 facing part of the articulating paper dispenser 10. The fastener bores 46 may be used to mount the dispenser 10 to a wall 108, such as a building wall or a cabinet wall.

Referring to FIGS. 1-10, the opposed sides of the housing 14 may have a suitable structure. One of the opposed sides may be an open side, and may be defined by a paper-roll insertion door 35 that covers the open side. The side door 35 may define an inner face 35A, an outer face 35B, and paper-roll spool parts such as spool posts 35C extended from the inner face 35A. The other of the opposed sides may be defined by a closed side wall 37, that forms a cover wall. The door 35 may be connected by a suitable hinge 84 with hinge parts, to the housing 14, such as to the top wall 28. The closed side wall 37 may define an inner face 37A, an outer face 37B, and a plurality of paper-roll spool parts, such as spool post receiver parts 37C, which may cooperate with posts 35C to collectively form a spool 86. The side door 35, side wall 37, and peripheral encircling wall 15 may cooperate to define the articulating-roll-receiving interior 40 of the housing 14.

Referring to the FIGS. 1-10, the blade arm 50 may have a suitable structure. The blade arm 50 may depend below a base of the housing 14, such as below base face 34B of the base wall 34. The blade arm 50 may comprise a branch base part 52 and a stem part 54, such as a terminal stem part as shown. The branch base part 52 may comprise a top face 52A. The terminal stem part 54 may comprise an inside face 54A. The terminal stem part 54 may mount the paper-cutting blade 60. The branch base part 52 may depend from at or near a rear end of the housing 14, for example the bottom edge 20 of the rear wall 16. The terminal stem part 54 may extend parallel with an underside of the base wall 34 of the housing 14 to define the finger-receiving pincer zone 70, for example the top face 52A of the branch base part 52 may oppose the outer face 34B of the base wall 34. The finger-receiving pincer zone 70 may be structured to allow a user's fingers 106 to fit into the finger-receiving pincer zone 70. The pincer zone 70 may be sized so that the user's fingers 106 do not come into contact with the retainer 12 or the blade arm 50 and only come into contact with articulating paper strip 112 located within the mouth gap 72. Thus, the zone 70 may have a suitable depth 154 wide enough to permit an average adult's pincer fingers to insert with ample clearance from the stem part 54 and housing 14. In some cases, the zone 70 may have a depth 154 of two or more times the width of an average adult's pincer fingers, which may refer to the index finger, middle finger, and thumb. The blade arm 50 thus acts as an extended portion that forms a void between the retainer housing 14 and arm 50 over which the strip of paper may be suspended so as to provide a location into which a user may locate their fingers to grasp the paper when a new portion thereof is desired. The user may, having gripped the strip 112, draw the strip 112 out of the mouth gap, apply sufficient axial pressure to withdraw additional strip 112 out of the outlet 42, and below the blade arm 50, and thereafter engage the strip 112 with the blade cutting tip 63 at an intermediate point of the paper to cut the paper after a sufficient length of paper is drawn below the cutting tip 63 for use.

Referring to FIGS. 1, 4, 6 and 8-9, the paper-cutting blade 60 may have a suitable structure. A lateral terminal tip 56 of the terminal stem part 54 may be structured to receive and mount the paper-cutting blade 60. The lateral terminal tip 56 may have opposed side guides 62. The blade 60 may span between the opposed side guides 62. An anchor part 61 or stem of the blade 60 may be connected, for example inserted into a corresponding blade-receiving slot 82 within, the terminal tip 56 of the terminal stem part 54. A cutting tip 63 of the blade 60 may oppose the anchor part 61 of the blade 60 and may be sized and shaped to permit cutting of the strip 112. The cutting tip may have a suitable shape, such as a straight edge blade, or a serrated blade, with a width equal to or greater than a width of the articulating paper.

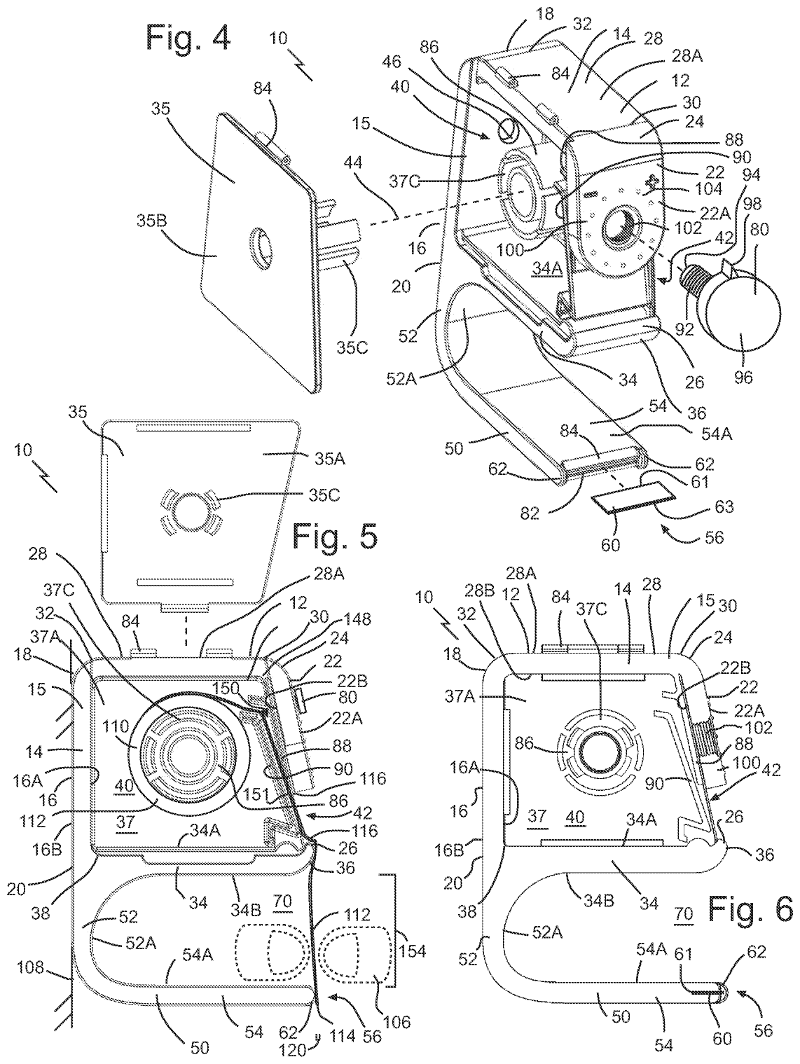

Referring to FIGS. 4-6, the dispenser 10 may be structured to directly fit an articulating paper roll 110 rather than a cartridge with a roll. The paper roll 110 may be mountable within the articulating-roll-receiving interior 40 of the articulating paper dispenser 10, for example slid along axis 44 onto the spool 86. Once the roll 110 is mounted securely on the spool 86, the end 114 of the paper may then be drawn off the roll and through the paper outlet 42. To facilitate egress of the paper from the roll 110 and interior 40, the housing 14 may form guide structure to assist the paper on its way to the outlet 42. A cantilever part 88 may depend from an inner surface, such as inner face 28B of top wall 28, of the housing 14 in the articulating-roll-receiving interior 40. The housing may form an articulating-paper ramp 90, which may extend upward from the inner face 34A of the base wall 34. The strip 112 may be fed from the paper roll 110 through a channel 150 defined between the cantilever part 88 and the articulating-paper ramp 90. The channel 150 may be structured to have suitable dimensions, such as an equal or greater a thickness and lateral width as the thickness 120, and a lateral width 118 of the strip 112 itself, to permit the strip 112 to move along its axis through the channel 150. The strip 112 may thereafter exit the housing 14 through the paper outlet 42. A portion 116 of the strip 112 may hang by gravity, in between uses, from the paper outlet 42 to at or near the blade 60 of the blade arm. A terminal end 114 of the strip 112 may rest at, near, or against the blade 60.

Referring to FIGS. 4-6, the dispenser 10 may comprise a pressure adjuster part 80. The pressure adjuster part 80 may be structured to allow a user to selectively apply adjustable friction pressure to the articulating paper that is mounted within the articulating-paper-roll retainer 12, for example on the spool 86. The pressure adjuster part 80 may comprise an advanceable and retractable part, such as a threaded knob. The threaded knob may comprise a knob head part 96 and a threaded base part 92. The knob part 96 may mount a friction indicator pointer or part 98. A terminal end 94 of the threaded part 92 may oppose the knob part 96. The housing 14 may comprise a pressure-adjuster-part receiver 100. The receiver 100 may comprise a threaded through bore 102 and a friction indicator dial 104. The threaded through bore 102 may be structured to receive and permit controllable axial advancement and retraction of the threaded part 92 of the threaded knob. The pressure adjuster part 80 may be structured to apply adjustable friction pressure to one or more of the articulating paper roll 110 or the articulating paper strip 112. The friction indicator dial 104 may cooperate with the friction indicator part 98 to indicate to the user using a visual scale the friction pressure that the end 94 of the pressure adjuster part 80 is currently set at.

Referring to FIGS. 4-6, the end 94 may be oriented and located to provide selectable pressure on the paper strip 112, either directly on the strip 112, or indirectly via a cantilever part 88, to provide selectable and adjustable lateral pressure on the strip 112 in the channel 150. The pressure adjuster part 80 may comprise, or may be structured to engage, the cantilever part 88 for such a purpose. As above, the cantilever part 88 may be depend from top wall 28 within the articulating-roll-receiving interior 40 of the dispenser 10. The cantilever part 88 may be oriented to swing or pivot radially inward, relative to the spool axis 44, with advancement of the pressure adjuster part 80, for example the part 88 may be physically actuated by the terminal end 94 of the threaded part against the natural bias of the material and structure of the cantilever part 88 (that under a lack of external forces would otherwise remain in a neutral position wide enough to pass the paper strip 112 unhindered) to pivot the part 88 inward. The advancement of the pressure adjuster part 80 may be used to selectively reduce a minimum articulating paper thickness gap 151 defined in the channel 150 between the articulating-paper ramp 90 and the cantilever part 88. The cantilever part 88 and articulating-paper ramp 90 may be located at or near a front end of the articulating-roll-receiving interior 40, for example at or near the front wall 22, although in other cases these parts may be elsewhere on the housing 14. Pressure applied to the cantilever part 88 may cause the cantilever part 88 to bend, move and/or pivot, for example around pivot point 148 (FIG. 5). Pressure applied to the cantilever part 88 from the terminal end 94 may cause the cantilever part 88 to pivot or move around point 148 or pivot region, which may cause the channel 150 to be reduced, which may result in an increase of the friction applied to the strip 112 by the dispenser 10. When pressure from the terminal end 94 applied to the cantilever part 88 is removed, the cantilever part 88 may relax, and pivot or move around point 148, which may cause the channel 150 to be increased, eventually returning to the neutral, unpivoted position. Adjustable pressure may assist in retaining the loose end 114 of the strip 112 in a static position in the channel 150 in between usages of the dispenser 10, so that the strip 112 does not recoil back into the paper roll 110, otherwise requiring a re-feeding of the end 114 through the channel 150 and outlet 42. The pressure on the paper may be selected to provide sufficient static friction to retain the paper in place when the paper is not under any axial external force from a user, yet providing a relatively low frictional barrier to movement as directed by the user, when the user desires to pull the strip 112 out of the outlet 42.

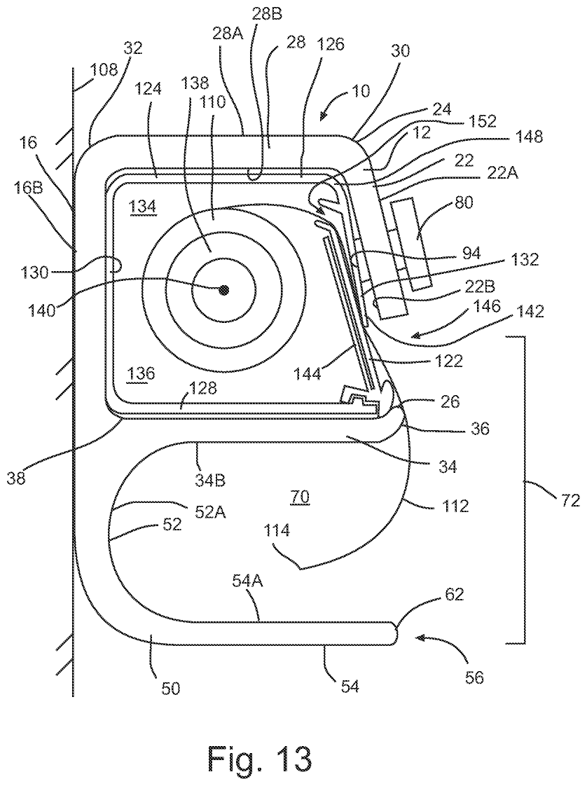

Referring to FIGS. 11 and 13, the dispenser 10 may be structured to retain a cartridge 122 for an articulating paper roll 110, rather than simply retaining a roll 110 on its own. An example cartridge 122 is structured to house a roll 110 of articulating paper within a protective casing or housing 124. The design of the cartridge 122 may provide convenient dispensing of the articulating paper (such as strip 112) while maintaining sterility and minimizing waste. In the example shown, the housing 14 may be structured to hold a Bausch Arti-Check® Articulating Paper—Roll-in Dispenser cartridge 122. The example cartridge may include an articulating paper that is extremely thin and tear resistant, for example 40 micron papers or less, used for occlusion tests. Due to the thin material and special coating with liquid colors, these papers facilitate accurate marking of all occlusal contacts or occlusal interferences.

Referring to FIGS. 11-13, the articulating-paper-roll retainer 12 may be structured to receive an articulating-paper-roll cartridge 122 in a suitable fashion. The interior 40 may be shaped to conform to the external dimensions of an articulating-paper roll cartridge 122, to facilitate the mounting of the cartridge 122 within the articulating-roll-receiving interior 40. The cartridge 122 may comprise a housing 124. The housing 124 may comprise a top wall 126, a base wall 128, a real wall 130, a front wall 132 and side face walls 134. The top wall 126 may be sized to abut the top wall 28 of the retainer 12. The base wall 128 may be sized to abut the base wall 34 of the retainer 12. The rear wall 130 may be sized to abut the rear wall 16 of the retainer 12. The front wall 132 may be sized to abut the front wall 22 of the retainer 12. The top wall 126, the base wall 128, the real wall 130, the front wall 132 and the side face walls 134 may define a hollow interior 136 of the cartridge 122. A spool 138 may be housed within the hollow interior 136 of the cartridge 122. The spool 138 may be structured to support an articulating paper roll 110 and permit the roll 110 to rotate around the spool 138, for example around axis 140. An articulating paper strip 112 may be withdrawn from the paper roll 110 and fed through a channel 152 formed between a cantilever part 142 and an articulating-paper ramp 144 of the cartridge 122. The strip 112 may thereafter exit the cartridge 122 through a paper outlet 146. The pressure adjuster part 80 may be structured, in such a case, to engage the cantilever part 142 of an articulating-paper roll cartridge 122 mounted within the articulating-roll-receiving interior 40. The adjuster part 80 may be positioned to engage the cantilever part 142 when the threaded part 92 of the adjuster part 80 is threaded through the threaded through bore 102, and the threaded part 92 is advanced. The terminal end 94 of the adjuster part 80 may apply a pressure selected from a range of selectable pressures to the cantilever part 142. Pressure applied to the cantilever part 142 may cause the cantilever part 142 to bend, move or pivot, for example around pivot point 148 (FIG. 13). Pressure applied to the cantilever part 142 from the terminal end 94 may cause the cantilever part 142 to pivot or move around point 148, which may cause the channel 152 to be reduced, which may result in an increase of the friction applied to the strip 112 by the dispenser 10. When pressure from the terminal end 94 applied to the cantilever part 142 is removed, the cantilever part 142 may pivot or move around point 148, which may cause the channel 152 to be increased, which may result in a decrease in the friction applied to the strip 112 by the dispenser 10.

Although the cartridge void is illustrated as extending completely through the body, it will be appreciated that it may optionally include an enclosing wall (not shown) across the cartridge void so as to prevent a cartridge from being removed from the cartridge void, such as interior 40, in one direction. As illustrated in FIGS. 4 and 12, the rear wall 16 may include one or more mounting bores 46 therethrough for passing a fastener to secure the dispenser 10 to a wall or other surface. The threaded bore 102 in the front wall 22 may be structured to align with one or more of the mounting bores 46 in the rear wall 16 to facilitate passage of a screwdriver or bit to permit a user to apply a fastener through the bore 46 straight on to secure the housing 14 in place on the wall 108. As illustrated in the attached figures, the apparatus is adapted for use with a Bausch™ cartridge although it will be appreciated that other cartridge types may be utilized as well. Optionally, as illustrated in the figures, a securing device, such as by way of non-limiting example may be provided through one of the front, rear, top or bottom walls to tighten against and thereby secure the cartridge within the cartridge void. Once the cartridge is secured within the cartridge void, tape from the cartridge may be passed through the opening to hang freely within the void there below. When a user desires a portion of the strip, they may grab the strip within the void and pull it down and over the blade until the strip is cut so as to provide a desired length of the strip of bite registration paper.

It will be appreciated that although the apparatus is described for use with bite registration tape that it may also be utilized for use with other strips of paper and other materials as well. While specific embodiments have been described and illustrated, such embodiments should be considered illustrative only and not as limiting the disclosure as construed in accordance with the above description.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

| | |
|---|---|
| 10 articulating paper dispenser | 62 side guides |
| 12 retainer | 63 cutting tip of blade |
| 14 housing | 70 finger receiving pincer zone/gripping void |
| 15 peripheral encircling wall | 72 mouth gap |
| 16 rear wall | 80 pressure adjuster part/securing device |
| 16A inner face | 82 blade receiving slot |
| 16B outer face | 84 front edges inset from side guides |
| 18 top edges | 84 hinge for door |
| 20 bottom edges | 86 spool |
| 22 front wall | 88 cantilevered door leaf |
| 22A outer face | 90 articulating paper ramp |
| 22B inner face 24 top edges | 92 threaded part |
| 26 bottom edges | 94 terminal end of threaded part |
| 28 top wall | 96 knob part |
| 28A top face | 98 friction indicator part |
| 28B base face | 100 adjuster part receiver |
| 30 front edge | 102 threaded through bore |
| 32 rear edges | 104 friction indicator dial |
| 34 base wall | 106 User |
| 34A top face | 108 building wall |
| 34B base face | 110 roll of bite registration paper |
| 35 side door | 112 paper strip |
| 35A inside face | 114 terminal end |
| 35B outside face | 116 paper part that hangs from paper outlet |
| 35C spool posts | 118 width of paper |
| 36 front edges | 120 thickness |
| 37 closed side wall | 122 cartridge |
| 37A inside face | 124 housing |
| 37B outside face | 126 top wall |
| 37C spool post receiver parts | 128 base wall |
| 38 rear edges | 130 rear wall |
| 40 articulating roll receiving interior/cartridge void | 132 front wall |
| 42 paper outlet | 134 side face walls |
| 44 axis | 136 hollow interior |
| 46 include one or more mounting bores | 138 spool |
| 50 blade arm/extended portion | 140 axis of spool |
| 52A top face of 52 | 142 cantilevered cartridge door leaf |
| 52 branch base part/first vertical portion | 144 upright tongue part |
| 54 terminal stem part/second horizontal portion | 146 paper outlet |
| 54A inside face of 54 | 148 Pivot point |
| 56 terminal end/free distal end | 150 channel of 1st embodiment |
| 60 blade | 152 channel of 2nd embodiment |
| 61 anchor part of blade | 154 zone depth |

1. An articulating paper dispenser comprising:
an articulating-paper-roll retainer with a housing that defines an articulating-roll-receiving interior and a paper outlet;
a blade arm extended from the housing and defining a finger-receiving pincer zone between the housing and the blade arm, the blade arm mounting a paper-cutting blade that is oriented to cut articulating paper that extends, in use, across a mouth gap that opens into the finger-receiving pincer zone and is defined between the paper outlet and the paper-cutting blade.

2. The articulating paper dispenser of claim 1 in which the blade arm depends below a base of the housing.

3. The articulating paper dispenser of claim 2 in which:
the blade arm comprises a branch base part and a stem part;
the stem part mounts the paper-cutting blade; and
the branch base part depends from at or near a rear end of the housing.

4. The articulating paper dispenser of claim 4 in which the stem part extends parallel with an underside of the base of the housing to define the finger-receiving pincer zone.

5. The articulating paper dispenser of claim 3 in which a lateral terminal tip of the stem part mounts the paper-cutting blade.

6. The articulating paper dispenser of claim 1 further comprising a pressure adjuster part structured to apply adjustable friction pressure to articulating paper that is mounted, in use, within the articulating-paper-roll retainer.

7. The articulating paper dispenser of claim 6 in which the pressure adjuster part comprises a threaded knob.

8. The articulating paper dispenser of claim 6 in which the pressure adjuster part comprises, or is structured to engage, the articulating paper or a cantilever part that is, at least in use, within the articulating-roll-receiving interior and is oriented to swing radially inward with advancement of the pressure adjuster part, to selectively reduce an articulating-paper-thickness gap defined between an articulating-paper ramp and the cantilever part.

9. The articulating paper dispenser of claim 8 in which the cantilever part is mounted to depend from an inner surface of the housing in the articulating-roll-receiving interior.

10. The articulating paper dispenser of claim 9 in which the cantilever part and the articulating-paper ramp are located at or near a front end of the articulating-roll-receiving interior.

11. The articulating paper dispenser of claim 8 in which the pressure adjuster part is structured to engage a cantilever part of an articulating-paper roll cartridge mounted, in use, within the articulating-roll-receiving interior.

12. The articulating paper dispenser of claim 1 in which the articulating-paper-roll retainer is structured to receive, in use, an articulating-paper-roll cartridge.

13. The articulating paper dispenser of claim 1 in which the housing has a peripheral encircling wall that is split at a front part to define the paper outlet, with the peripheral encircling wall defining a paper roll mounting axis.

14. The articulating paper dispenser of claim 13 in which the housing defines opposed sides, which are bounded by the peripheral encircling wall, and one or more of which are open.

15. The articulating paper dispenser of claim 14 in which an open side of the opposed sides is defined by a paper-roll insertion door.

16. The articulating paper dispenser of claim 15 in which the other of the opposed sides is defined by a cover wall.

17. The articulating paper dispenser of claim 1 further comprising wall-mounting fastener holes in a rear wall facing part of the articulating paper dispenser.

18. A method comprising mounting an articulating paper roll within the articulating-roll-receiving interior of the articulating paper dispenser of claim 1.
